(19) United States
(12) Patent Application Publication
(10) Pub. No.: US 2026/0141293 A1
(43) Pub. Date: May 21, 2026

(54) ROBUST AI GENERATIVE FRAMEWORK FOR CONTEXTUAL INTELLIGENCE ALIGNMENT

(71) Applicant: Oracle International Corporation, Redwood Shores, CA (US)

(72) Inventors: Daniel Droder, Akron, OH (US); Saeid Allahdadian, Vancouver (CA); Ehsan Nick Minaie, Columbia, MD (US)

(73) Assignee: Oracle International Corporation, Redwood Shores, CA (US)

(21) Appl. No.: 19/044,488

(22) Filed: Feb. 3, 2025

Related U.S. Application Data
(60) Provisional application No. 63/721,256, filed on Nov. 15, 2024.

(51) Int. Cl. G06N 20/00

(52) U.S. Cl. CPC G06N 20/00

(57) ABSTRACT

A pre-trained context AI agent that was trained using one or more initial training data sets may be accessed. An input data set may be generated that includes a prompt and/or context to request generation of one or more synthetic data elements. A result that includes at least one synthetic data element may be accessed, where the result was generated by a natural language processing technique in response to the input data set. Identification a label for each of the at least one synthetic data element may be facilitated. The context AI agent may be fine-tuned using the label for each of the at least one synthetic data element.

### CROSS-REFERENCE TO RELATED APPLICATIONS

This application claims the benefit of and the priority to U.S. Provisional Patent Application No. 63/721,256, filed on Nov. 15, 2024, which is hereby incorporated by reference in its entirety for all purposes.

### BACKGROUND

Anomaly detection is an important process in data analysis, cybersecurity, and operational systems, where identifying unusual patterns or behaviors can signal issues, opportunities, or threats. In cybersecurity, anomaly detection helps identify potential breaches or malicious activities that deviate from typical user or system behavior, allowing for quick intervention and prevention of further damage. An anomaly may be a sign of unusual machine or network activity, which could lead to significant downtime if left undetected. However, detecting anomalies is very challenging, given (for example) the exceedingly high volume and variability of legitimate data.

### SUMMARY

In some instances, a computer-implemented method is provided that includes: accessing a pre-trained context AI agent that was trained using one or more initial training data sets; generating an input data set that includes a prompt and/or context to request generation of one or more synthetic data elements; accessing a result that includes at least one synthetic data element, wherein the result was generated by a natural language processing technique in response to the input data set; facilitating identifying a label for each of the at least one synthetic data element; and fine-tuning the context AI agent using the label for each of the at least one synthetic data element.

The computer-implemented method may further include one or more other actions. The one or more other actions may include receiving a new data element; generating one or more prediction variables by processing the new data element using the fine-tuned context AI agent; determining that an alert condition or action condition is satisfied based on the one or more prediction variables; and initiating an alert or action based on the determination. The one or more prediction variables may include a label for the new data element, where initiating the alert or action includes outputting a communication to a user device to request confirmation of, rejection of, or modification of the label for the new data element.

The one or more other actions may include identifying that each of one or more real data elements and/or one or more existing synthetic data elements are associated with a confidence metric that is below a relative or absolute threshold; where generating the input data set includes defining the prompt and/or context to include the one or more real data elements and/or one or more existing synthetic data elements as an example or template.

The one or more other actions may include identifying that each of one or more real data elements and/or one or more existing synthetic data elements that are within a set of client-specific data elements are associated with a prevalence metric that is below a relative or absolute threshold, wherein the prevalence metric is indicative of a degree of representation of a label, syntax, structure, or field inclusion within the client-specific data elements is below an absolute or relative threshold; where generating the input data set includes defining the prompt and/or context to include the one or more real data elements and/or one or more existing synthetic data elements as an example or template.

The result may be generated based on a confidence metric assigned to at least one label in the one or more initial training data sets.

The result may be generated based on a representation metric in a multi-dimensional space representing the one or more initial training data sets.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 illustrates a framework training, dynamically fine-tuning and using a context AI agent (CAIA).

FIG. 2 illustrates a flow diagram of a human-in-the-loop process for using multiple machine learning models to generate labels for data elements.

FIG. 3 depicts a process for fine-tuning a context agent configured to assign labels to data elements.

FIG. 4 illustrates a flowchart of a process processing data elements using a fine-tuned context AI (e.g., a fine-tuned context AI.

FIG. 5 depicts a simplified diagram of a distributed system for implementing an embodiment.

FIG. 6 is a simplified block diagram of a cloud-based system environment in which detecting, labeling and/or reporting anomalies and/or training one or more models therefor, in accordance with certain aspects.

FIG. 7 illustrates an exemplary computer system that may be used to implement certain aspects.

### DETAILED DESCRIPTION

Anomaly detection systems have evolved significantly over the years, employing sophisticated algorithms and machine learning techniques. However, as these systems have grown more advanced, they've also encountered increasingly complex challenges.

One challenge is data deluge, as the sheer volume of data being generated and analyzed has exploded. Organizations are now dealing with petabytes or even exabytes of data from diverse sources such as IoT devices, social media, transaction logs, and sensor networks. This data tsunami results in an overwhelming number of potential anomalies being flagged, far exceeding the capacity of human analysts to investigate manually.

Additionally, the diversity of data types and structures continues to increase. Modern datasets are not just large; they're also incredibly diverse. Anomaly detection systems now often handle structured data (like database entries), unstructured data (such as text and images), and semi-structured data (like JSON or XML files). Each data type presents unique challenges for anomaly detection algorithms.

Further, in many scenarios (e.g., fraud detection or network security), an important objective of anomaly detection is to detect anomalies (and act on them) in real-time or near-real-time. This puts immense pressure on the processing capabilities of anomaly detection systems.

Another challenge is that normal patterns evolve. That is, what constitutes “normal” behavior often changes over time, a phenomenon known as concept drift. For example, network traffic patterns may shift dramatically during a global event, or consumer spending habits might change due to economic factors. Anomaly detection systems struggle to adapt to these evolving baselines.

Anomalies also may be more complex than simple point anomalies. Rather, an anomaly may be a contextual and/or collective anomaly. Contextual anomalies are data points that are abnormal in a specific context. Collective anomalies are groups of related data points that are abnormal with respect to the entire dataset. These types of anomalies are far more challenging to identify accurately as compared to single point anomalies.

Yet another challenge relates to imbalanced and/or unlabeled data. In most real-world scenarios, anomalies are rare events, leading to highly imbalanced datasets. Moreover, obtaining labeled examples of anomalies is often difficult or impossible, making it challenging to train supervised machine learning models or evaluate the performance of unsupervised ones.

The combination of high data volumes and the rarity of true anomalies also often leads to a high rate of false positives. This flood of false alarms can quickly lead to alert fatigue among analysts, potentially causing them to miss critical true positives.

Further, as anomaly detection algorithms become more complex (particularly with the adoption of deep learning techniques), understanding why a particular data point or pattern was flagged as anomalous becomes increasingly difficult. This lack of interpretability can erode trust in the system and make it challenging for analysts to act on the detected anomalies.

The culmination of these challenges creates a critical problem: without an efficient, adaptive, and robust solution that can accurately filter, explain, and report aligned detections, anomaly detection systems are at risk of failing to serve their intended purpose. They may generate an unmanageable number of false positives, miss critical anomalies, or provide insights that are difficult to act upon.

This situation not only leads to inefficient use of resources but also exposes organizations to significant risks. In cybersecurity, missed anomalies could lead to undetected breaches. In financial services, it could result in undetected fraud. In manufacturing, it might mean overlooked defects or missed opportunities for process optimization.

Moreover, the lack of trust in anomaly detection systems due to high false positive rates and lack of explainability can lead to a dangerous situation where alerts are routinely ignored or the systems are underutilized, negating their benefits.

Some embodiments of the present invention relate to techniques for more reliably and accurately detecting and labeling anomalies, predicting a category of each detected anomaly, reporting potential anomaly characterizations, etc. More specifically, a feedback loop is created where human-in-the-loop outputs are dynamically generated based on predictions from a labeling-coordination model as to what types of human labels will improve performance of a Context AI Agent (CAIA). The labeling-coordination model may be configured to generate synthetic data for a human to label. The synthetic data may correspond to a type of data for which the labeling-coordination model predicts is underrepresented in a training set and/or is associated with lower confidences.

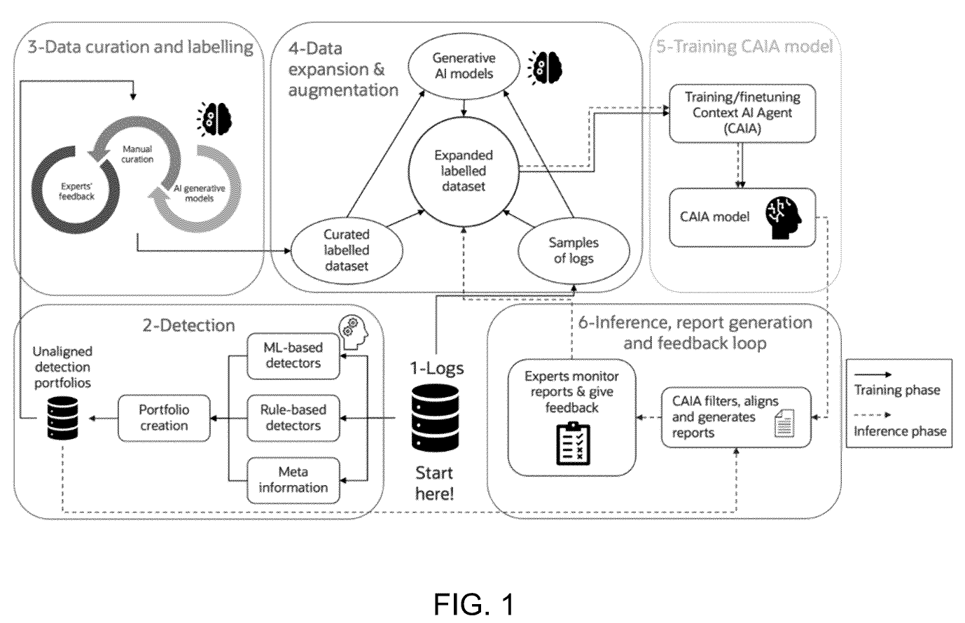

FIG. 1 illustrates a framework training, dynamically fine-tuning and using a context AI agent (CAIA).

At block 1, data aggregation occurs, where data is aggregated into a centralized location. This may be completed before the subsequent processes begin. The centralization of data allows relevant information to be readily accessible, such that it can be processed efficiently. The aggregation may involve collecting data from various sources, such as sensors, databases, or external APIs, and storing it in a unified format for easy retrieval and analysis.

At block 2, unaligned detection occurs. In this phase, one or more pre-configured pretrained anomaly-detection techniques are applied to the aggregated data. These techniques are designed to identify patterns, anomalies, or specific events of interest within the dataset. The output of this step is referred to as “unaligned detection portfolios.” These portfolios contain raw detections that have not yet been verified or refined by human experts, i.e. are not aligned to experts' interest. The techniques may include (for example) a statistical analysis, machine learning model, or rule-based system.

At block 3, data curation and labelling occurs, which results in unaligned detections being prepared for expert review. This involves organizing and presenting the data in a format that allows human experts to efficiently examine and label each detection. Here, one or more pretrained generative AI models (such as a large language model) can be used to generate some or all of the data to be routed for expert review.

The staging process may include generating and/or outputting user-friendly interfaces, prioritizing detections based on certain criteria, or grouping similar detections to streamline the labeling process. This can facilitate experts effectively contributing an important spectrum of their knowledge and insights to refine the detection results.

At block 4, a labeling-coordination model and one or more pretrained generative AI models is used to expand the curated, labeled dataset produced by the experts. That is, a labeling-coordination model can generate one or more prompts (e.g., and corresponding context) to feed to the pretrained generative AI model(s), which can result in generation of one or more synthetic data elements to avail to human experts for labeling.

By analyzing the characteristics and patterns of the expert-labeled detections and by analyzing at the patterns inside the raw logs, the generative AI model(s) generate new synthetic data points that closely resemble the authentic, labeled samples. This process significantly reduces the workload on human experts by creating a larger dataset for training purposes without requiring additional manual labeling. The result is an efficiently expanded labeled dataset that maintains the quality and accuracy of expert-curated data while increasing its volume and variety.

A prompt and/or context fed to the generative AI model(s) may be generated by a labeling-coordination model, which may be configured with a loss function based on performance of a context AI agent, based on uniformity of label presence in a multi-dimensional space that represents data elements, and/or based on a degree to which label presence is anti-correlated with label confidence in a multi-dimensional space.

For example, a prompt to a generative AI model may request that one or more data elements be generated that are similar to one or more exemplary data elements provided in a context. The one or more exemplary data elements may include real or synthetic data elements that correspond to low confidence metrics for labels (generated by a a context AI agent or by a human expert) and/or real or synthetic data elements that are relatively unrepresented in a labeled training set.

As another example, a prompt to a generative AI model may request generation of a set of data elements that are to be reviewed collectively to determine whether the set is to be flagged as an anomaly. The context may provide one or more exemplary data sets that were labeled as an anomaly and/or one or more exemplary sets that were labeled as not being an anomaly.

As still another example, a prompt to a generative AI model may request generation of a data element along with one or more associated pieces of information (e.g., one or more historical metrics pertaining to a source of the data element, one or more metrics pertaining to prior labels assigned to a source of the data element, a recent quantity of total data elements received across sources, etc.). The prompt may (but need not) be accompanied by a context that includes one or more exemplary data sets.

At block 5, a context AI agent is developed and/or fine-tuned using an expanded labeled dataset that includes labels for the expanded dataset generated at block 4. The context AI agent can be configured to determine, for each incoming data element, whether it is to be flagged (e.g., for review, alert or action). If so, the context AI agent can assign a category or pattern type to the data element. In some instances, assigning a particular type of category to a flag triggers an action, such as blocking access or declining a request.

At block 6, the context AI agent is used to process new (e.g., real-time) data and/or unaligned detection portfolios generated in Step 2. For each of some or all data elements, the context AI agent may generate an interpretation of an output (e.g., binary output or categorization), a binary output (e.g., indicating a prediction as to whether the data element is sufficient to warrant review or action), a predicted probability (e.g., of a data element being a concern, a threat, or warranting action), and/or a predicted category of the data element (e.g., a predicted anomaly category).

A report—or content for a report—can also be generated. The report or report content can represent one or more results of the processing. For example, the report may identify some or all of the new data corresponding to a particular binary value corresponding to a flag, to a probability that exceeds a predefined threshold or to one or more particular category. One or more metrics may also be included in the report, such as a total count of flagged data elements, a percentage of data elements that were flagged, a count or percentage per category, etc. The report may have a format and/or variables that correspond to that from block 3. For example, a report may include a count, percentage or frequency of data elements assigned to each of a set of categories defined from block 3 (e.g., true positive, false positive, benign positive, false positive, etc.). The report may have a report or structure corresponding to a desired platform, such as Jira, MQ, etc.

The report can also include an explanation as to why—for any instance for which an output is being flagged, is assigned to a particular category or for which an anomaly probability is relatively high—such a result was generated. The explanation can be based on and consistent with one or more conditions, rules or algorithms used during the processing of the real-time data. The explanation may include a natural-language explanation or pseudocode.

The binary outputs, predicted probabilities and/or predicted categories can be used to configure a transmission, such as an email, online interface update (e.g., HTTP response), text message, etc. Each of the binary outputs, predicted probabilities and/or predicted categories may also be evaluated using one or more predefined conditions to determine whether to trigger a given computational action (e.g., blocking a request, blocking a user account, blocking an IP address, reporting a request, etc.).

In some instances, some or all of the output from block 6 is availed for expert review. Any label confirmation, submission and/or revision provided by an expert may be used to further fine-tune the context AI agent and/or the labeling-coordination model.

Thus, some embodiments disclosed herein provide a framework with an intelligent feedback mechanism that facilitates efficient and adaptive fine-tuning of models. In various embodiments, the fine-tuning may occur at different levels, such that expert feedback, synthetic data-element generation and/or result generation can be performed so as to be tailored for a given IP address, a given user (e.g., that is predicted to use multiple devices), a given system, etc.

The results are further generated and provided in a contextualized manner. The categories and confidence scores also facilitate interpretability. This occurs despite the unpredictability, drift (in terms of incoming data and expert labeling) and variability of a massive amount of incoming data. Thus, efficiency is improved for both expert and developer teams; interpretability is improved with automated reporting and integration; false positives are decreased; alignment between experts points of interest and detection are increased; and integration with incident management systems are improved.

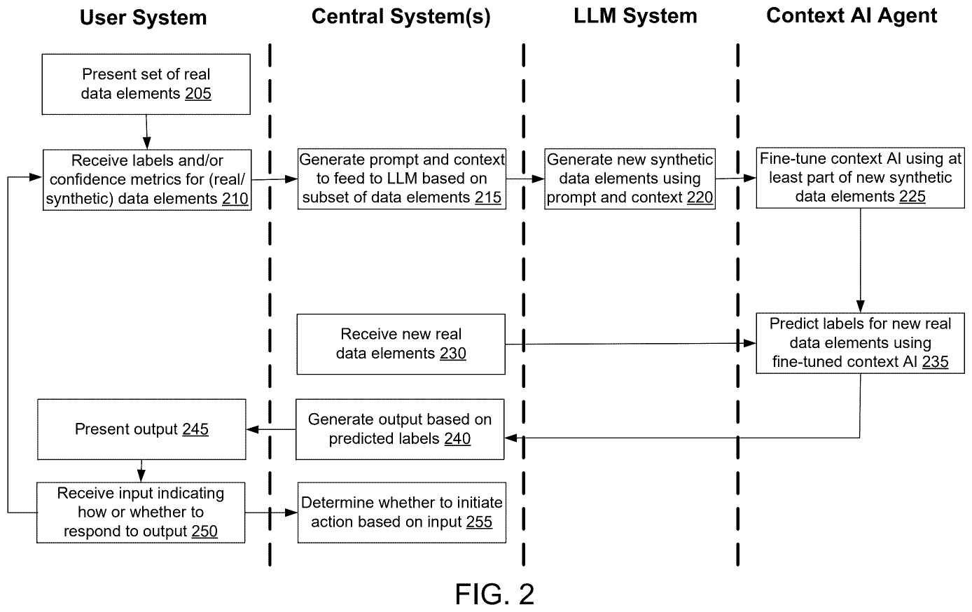

FIG. 2 illustrates a flow diagram of a human-in-the-loop process for using multiple machine learning models to generate labels for data elements.

At block 205, each of a set of real data elements is presented at a user system. Each of the set of real data elements may include (for example) a log message (e.g., representing login attempts, system requests, configuration changes, privilege escalation, file-access requests, data exfiltration, file modifications, etc.), a combination of performance metrics for a computing system or virtual machine (e.g., memory usage, processor usage, latency, etc.), a time series of network traffic, server statistics (e.g., uptime, temperature, power consumption, fan speed, etc.), one or more statistics representing website usage over time (e.g., a number of sessions over a given time period, a frequency of website sessions or requests, a median or average latency between HTTP requests for a website, etc.), one or more database performance statistics (e.g., latency, resource usage, etc.), etc.

The set of real data elements may have been collected by a client associated with the user device on a local or remote system associated with the client. In some instances, part or all of the set of real data elements were generated, stored and/or availed by one or more central systems. For example, the central system(s) may provide cloud resources to the client, to support the client availing one or more services or processing to its customer base, and the central system(s) may generate the real data elements based on such interactions and/or backend support (e.g., memory usage, response latency, processor usage, etc.). Thus, some or all of the set of real data elements may be uploaded by or identified by a user associated with the user system, and/or some or all of the set of real data elements may be generated by, retrieved by, and/or availed by the central system(s).

At block 210, for each of the real data elements, a label (and potentially, a confidence metric) are received. For example, the label (and potentially, the confidence metric) may be received via a user interface of the user system. The user interface may be configured to receive one or more user inputs via an input component, such as a keyboard, mouse, track pad, touchscreen, etc. The input(s) can be mapped to a label option and/or confidence metric option (e.g., based on associating a position of a cursor with a presented label option, associating text input with a label option, etc.).

As one example, a first potential label option may indicate that (for example) the data element is not suspicious, accords with predefined requirements, is to be permitted/processed, etc. A second potential label option may indicate that (for example) the data element is to be rejected, is to automatically trigger an action (e.g., blocking a user or IP address, reporting the data element to an authority), etc. Confidence metric options may include numerical or categorical options corresponding to a degree to which the user is confident as to whether to assign the data element to the first label option versus the second label option.

It will be appreciated that other potential label options are contemplated. For example, label options may span continuous or discrete numbers along a predefined scale that correspond to threat or maliciousness risk. Confidence metrics may then be (for example) inferred based on the label options or may be estimated based on the confidence metrics and potentially one or more other factors (e.g., pertaining to automated assessments, variables input by the client, detected variables, etc.).

As another example, label options may correspond to various routing directions—where each routing direction may indicate that content associated with the data element is to be routed to a given workflow (e.g., associated with a team of client representatives, a client action, a team of central-system representatives, a central-system action, etc.). It will be appreciated that—in any label-option situation—part or all of one or more labels may indicate a confidence as to whether a give label option is to be assigned.

At block 215, a prompt and/or context is generated based on a subset of the data elements received at block 215. The central system(s) may identify the subset at least partly based on the labels and/or confidence metrics received at block 210. For example, it may be determined or estimated that individual data elements and/or data-element characteristics correspond to relative or absolute confidence metrics that are below an absolute or relative threshold. As another example, it may be determined or estimated that individual data elements and/or one or more data-element characteristics are underrepresented in the data elements received at block 210 and/or used for any prior training of a context AI model. As yet another example, it may be determined or estimated that individual data elements and/or data-element characteristics are relatively more important with respect to other individual data elements and/or data-element characteristics. The subset may then be defined based on, for example, the data elements and/or data-element characteristics that are identified (e.g., based on the confidence metrics, representation and/or importance).

The central system(s) may generate a prompt that requests generation of synthetic data elements that correspond to the subset. As one example, a prompt may be generated that requests a given number of synthetic data elements that are similar to one or more examples provided in a context. The subset of the data elements may be provided in the context.

At block 220, one or more new synthetic data elements can be generated by an LLM system using the prompt and/or context. In some instances, the prompt and/or context generated at block 215 are output to the LLM system subsequent to block 215, and block 220 can be performed subsequently or responsively. The LLM system may be a system that coordinates an LLM and/or natural language processing (NLP) technique within or external to the central system(s). A label for each of the new synthetic data element may also be predicted. For example, the LLM system may identify one or more examples of data elements to which a particular label was assigned, so it may be predicted that the new synthetic data elements have the same label.

The new synthetic elements can be returned and/or availed to the central system(s) and/or the context AI agent. In the former case, the central system(s) may send a request to the context AI agent to fine-tune the context AI using at least part of the new synthetic data.

At block 225, the context AI agent fine-tunes the context AI using at lease some of the new synthetic data elements. The fine-tuning can result in an adjustment to some weights of the context AI.

At block 230, one or more new real data elements are received by the central system(s). The one or more new real data elements may be (for example) automatically generated by the central system(s) based on interactions from one or more devices with resources assigned to a client associated with the user system. As another example, the new real data elements may be received as a result of the user system transmitting the one or more new real data elements to the central system(s).

At block 235, the context AI agent uses the fine-tuned context AI (from block 225) predicts a label for each of the new real data elements.

At block 240, the central system(s) generates an output that is sent to the user system, where the output is based on the predicted labels. For example, the output may include—for each of a subset of the one or more new real data elements—a label for at least one or more new data elements, a confidence metric for the label, and/or a recommended action (e.g., to complete or decline a request; to flag a potential security issue; etc.). The confidence metric may include a number or categorical value indicating a confidence of the predicted label.

The output can be transmitted from the central system(s) to the user system, and the user system can present the output at block 245. The presented output may include presentations of one or more clusters of new real data elements, where the clusters may be based on (for example) recommended actions, labels, etc. The output can be presented in a user interface that includes one or more input components configured to receive input—corresponding to one or more of the new real data elements—that are configured to receive input that indicates: whether to confirm, change or reject a predicted label; an action to initiate based on a predicted label (or a changed label); whether to initiate any action; etc.

At block 250, one or more inputs may be received that indicates how or whether to respond to the output. The one or more inputs may be received via the one or more of the input components. For example, the input may indicate—for a given real data element—whether to confirm, change or reject a predicted label; whether to initiate any action; that identifies an action to be initiated; etc. Such input can be communicated from the user system to the central system(s).

In some instances, the input may be evaluated to determine whether and/or what additional real and/or synthetic data elements are to be availed to facilitate training the LLM (e.g., thereby returning to block 210). For example, a separate machine-learning model or a predefined rule may be used to determine whether a given data element from the new real data elements is to be used to further fine-tune the context AI and/or to be used to generate one or more synthetic data elements to be used to fine-tune the context AI. Therefore, the process of FIG. 2 may continue from block 250 to block 210 and/or to block 220. A filtering process may be performed in between to select a subset of the new real data elements (e.g., and corresponding labels) to use for the fine-tuning and/or for generation of new synthetic data elements. It will be appreciated that, when the process revers for such fine-tuning, the fine-tuning may occur using only the identified select data elements (and not other data elements), using on synthetic data elements generated based on the select data elements, or a combination thereof. Thus, in some instances, blocks 215 and 220 are omitted subsequent to at least one iteration returning from block 250.

At block 255, the central system(s) determines whether to initiate any action based on the input received at block 250. If so, the central system(s) may determine a particular action to be potentially initiated (e.g., to block a request, to report a request, to report an interaction, to block system resources, to grant a request, to release a security freeze, etc.). In some instances, the determination may be output (e.g., to user system) to request a confirmation, modification or rejection of the determination, and the action (or the modification thereof) may be automatically initiated upon receiving a confirmation or modification. In some instances, the determination can be evaluated based on a pre-defined criterion to determine whether to automatically initiate the particular action. The pre-defined criterion may (for example) include one or more of: a threshold for a confidence metric, a time-series trend criterion, a label specification, and so on. The determination may further or also include a selection (e.g., pseudo-random selection) where a predefined number or predefined percentage of data elements are selected for fine-tuning or to use to generate one or more synthetic data elements for fine-tuning.

If the pre-defined criterion is satisfied, the particular action may be automatically initiated and/or performed.

It will be appreciated that, for a given set of new real data elements received at block 230, the process may proceed from block 250 to one or both of blocks 210 and 255.

It will be appreciated that actions depicted in FIG. 2 may be performed in various orders. For example, some or all of blocks 205-225 may be performed concurrently with blocks some or all of blocks 230-255, such that (for example) outputs generated at block 240 are generated based on recent fine-tuning of the context AI, even if a subset of the some synthetic data elements has not been identified.

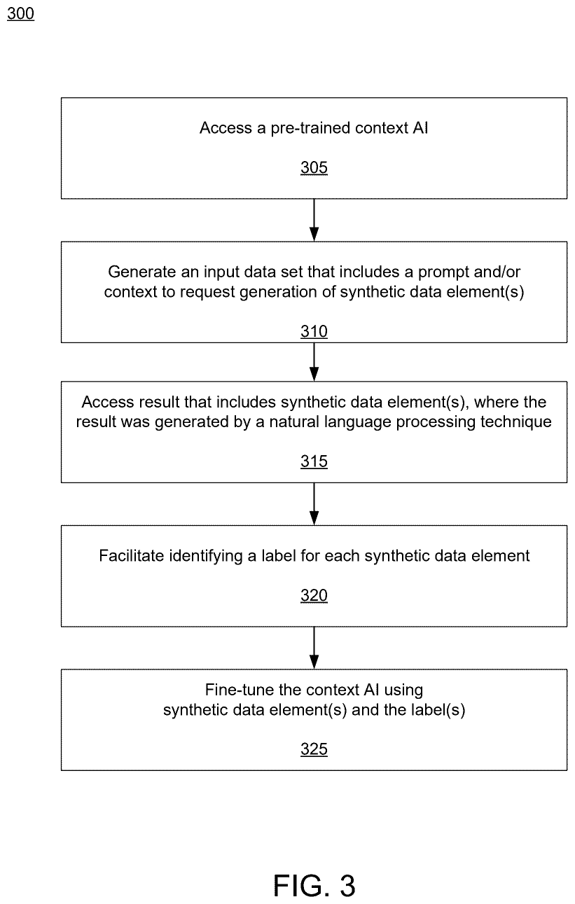

FIG. 3 depicts a process 300 for fine-tuning a context agent configured to assign labels to data elements. At block 305, a pre-trained context AI is accessed. The pre-trained context AI may include a model, such as an LLM, NLP, deep AI model, model including a transformer architecture, etc. The model may include a generalized model.

At block 310, an input data set is generated that includes a prompt and/or context to request generation of one or more synthetic data elements. The input data set may be generated by (for example) a labeling-coordination model and/or one or more central systems. The prompt and/or context can be defined in accordance with one or more descriptions herein. For example, the context may include one or more examples of real or synthetic data elements that are to serve as example(s) for the synthetic data element(s) that are to be generated. The input data set may be fed to an LLM or NLP tool.

At block 315, a result generated in response to a query that contains the input data set can be accessed. The result may include one or more synthetic data elements. The one or more synthetic data elements may include (for example) one or more structured data elements, one or more unstructured data elements, one or more data strings, one or more images, etc.

At block 320, for each of the one or more synthetic data elements, identification of a label is facilitated. In some instances, a label for a synthetic data element is inferred or predicted to be a label associated with the one or more real or synthetic data element(s) included in a context generated at block 310 and/or used to generate the result accessed at block 315. In some instances, a user interface is availed to a user system, where the user interface presents a synthetic data element and includes a user input component configured to receive input that identifies a label and/or that accepts/rejects/modifies a predicted label. Such a predicted label may be generated in accordance with a technique disclosed herein, such as inferring a label from data elements in a context generated at block 310.

At block 325, the context AI is fine-tuned using the synthetic data element(s) and the corresponding label(s). This fine-tuning process can involve adjusting the model's weights through iterative training cycles using a specialized loss function that minimizes prediction errors on the synthetic dataset. By incorporating these tailored data points, the AI model gains enhanced accuracy and adaptability for targeted applications, improving a degree to which it meets the desired functional requirements.

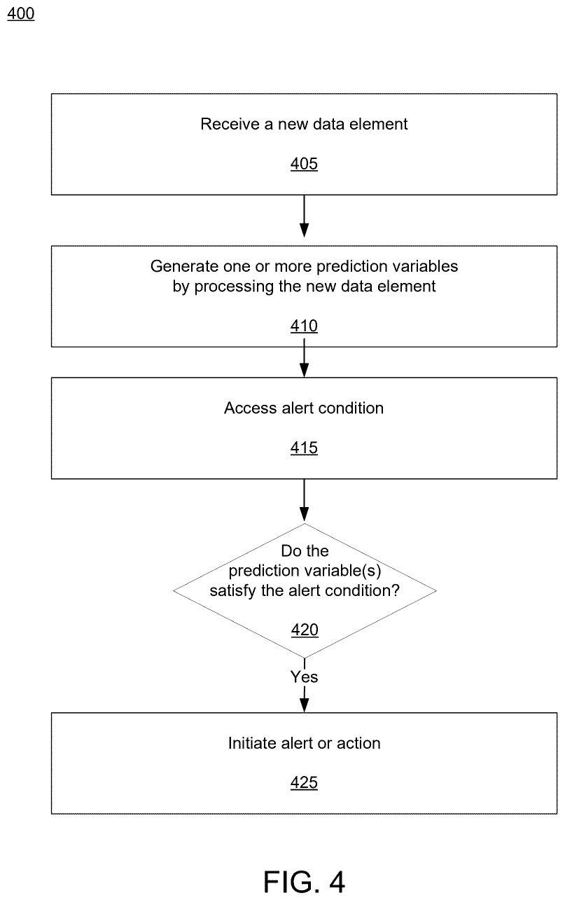

FIG. 4 illustrates a flowchart of a process 400 processing data elements using a fine-tuned context AI (e.g., a fine-tuned context AI generated via process 300). At block 405, a new data element is received. The new data element may have been automatically detected via a central system (e.g., cloud service providing system). The new data element may also have been uploaded or availed (e.g., to a central system) by a user system.

At block 410, one or more prediction variables can be generated by processing the new data element. The processing may occur using a context AI, such as a context AI fine-tuned in accordance with a technique disclosed herein and/or in accordance with process 300. The one or more prediction variables may include a predicted label and/or a confidence metric. The predicted label may be a label disclosed herein and/or selected from a set of labels that includes one or more labels disclosed herein, one or more labels identified via input from a user system, one or more auto-generated labels, etc.

At block 415, an alert condition is accessed. The alert condition may be (for example) predefined, set (in part or in its entirety) by a user system, learned, etc. The alert condition may be configured to receive—as input—one, more or all of the one or more prediction variables. The alert condition may be configured to output a binary, categorical, real-number, etc. output. For example, the alert condition may be configured to be satisfied if either: a confidence metric is below a first threshold and a predicted label is a particular first label; or a confidence metric is below a different second threshold and a predicted label is a particular second label.

At block 420, it is determined whether the alert condition is satisfied. The determination can be based on one or more of the prediction variables. If the alert condition is satisfied, process 400 continues to block 425, where an alert or action is initiated or performed. For example, an alert may be generated that includes the new data element and one or more prediction variables. The alert may be transmitted to a user system and presented using a user interface that accepts input to indicate (for example) whether a predicted label is correct, to refine a confidence metric, to request that other synthetic data elements be generated that are similar to the new data element, to initiate an action, etc. An action that may be initiated automatically (e.g., if an alert condition is satisfied corresponding to a high confidence and particular label) or upon user approval. An action may include (for example), blocking a request, reporting the new data element, storing information about the new data element, or granting a request.

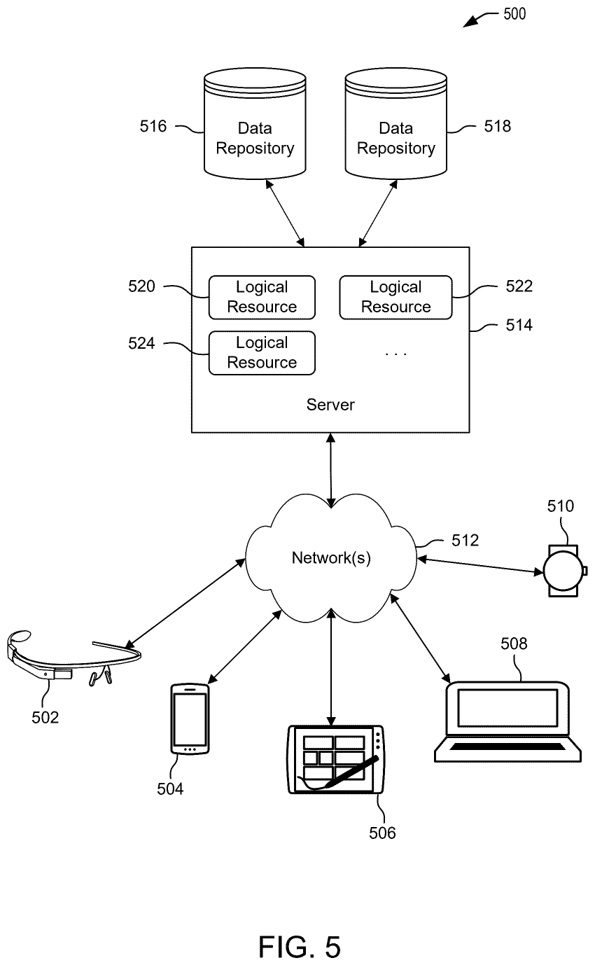

FIG. 5 depicts a simplified diagram of a distributed system 500 for implementing an embodiment. In the illustrated embodiment, distributed system 500 includes one or more client computing devices 502, 504, 506, 508, and/or 510 coupled to a server 514 via one or more communication networks 512. Client computing devices 502, 504, 506, 508, and/or 510 may be configured to execute one or more applications.

In various aspects, server 514 may be adapted to run one or more services or software applications that enable techniques for detecting, labeling and/or reporting anomalies and/or training one or more models therefor.

In certain aspects, server 514 may also provide other services or software applications that can include non-virtual and virtual environments. In some aspects, these services may be offered as web-based or cloud services, such as under a Software as a Service (SaaS) model to the users of client computing devices 502, 504, 506, 508, and/or 510. Users operating client computing devices 502, 504, 506, 508, and/or 510 may in turn utilize one or more client applications to interact with server 514 to utilize the services provided by these components.

In the configuration depicted in FIG. 5, server 514 may include one or more components 520, 522 and 524 that implement the functions performed by server 514. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, 508, and/or 510 for techniques for detecting, labeling and/or reporting anomalies and/or training one or more models therefor in accordance with the teachings of this disclosure. A client device may provide an interface that enables a user of the client device to interact with the client device. The client device may also output information to the user via this interface. Although FIG. 5 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 514 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 514 can include one or more virtual machines running virtual operating systems, or other computing architectures involving virtualization such as one or more flexible pools of logical storage devices that can be virtualized to maintain virtual storage devices for the server. In various aspects, server 514 may be adapted to run one or more services or software applications that provide the functionality described in the foregoing disclosure.

The computing systems in server 514 may run one or more operating systems including any of those discussed above, as well as any commercially available server operating system. Server 514 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 514 may include one or more applications to analyze and consolidate data feeds and/or event updates received from users of client computing devices 502, 504, 506, 508, and/or 510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 514 may also include one or more applications to display the data feeds and/or real-time events via one or more display devices of client computing devices 502, 504, 506, 508, and/or 510.

Distributed system 500 may also include one or more data repositories 516, 518. These data repositories may be used to store data and other information in certain aspects. For example, one or more of the data repositories 516, 518 may be used to store information for techniques for detecting, labeling and/or reporting anomalies and/or training one or more models therefor. Data repositories 516, 518 may reside in a variety of locations. For example, a data repository used by server 514 may be local to server 514 or may be remote from server 514 and in communication with server 514 via a network-based or dedicated connection. Data repositories 516, 518 may be of different types. In certain aspects, a data repository used by server 514 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 516, 518 may also be used by applications to store application data. The data repositories used by applications may be of different types such as, for example, a key-value store repository, an object store repository, or a general storage repository supported by a file system.

In one embodiment, server 514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

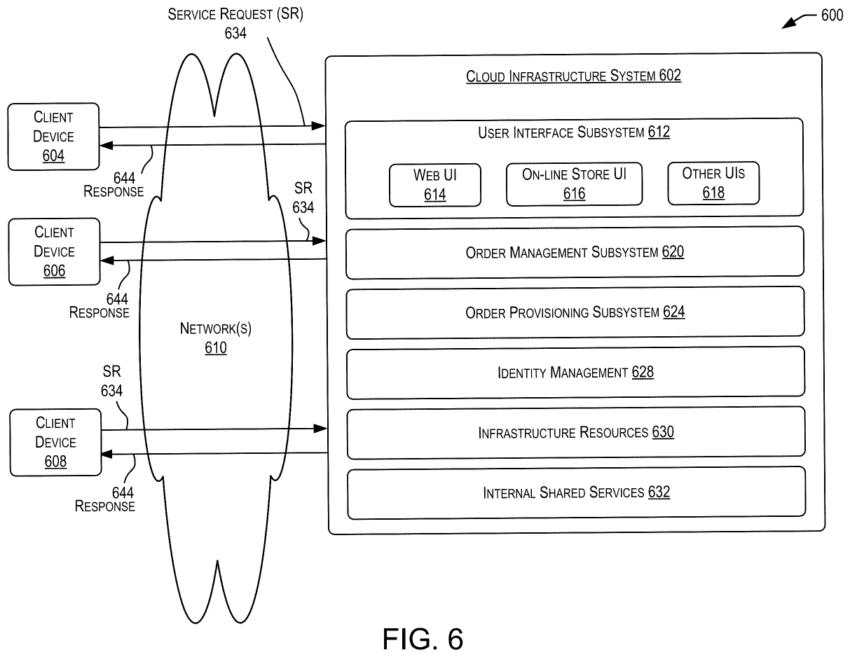

FIG. 6 is a simplified block diagram of a cloud-based system environment in which detecting, labeling and/or reporting anomalies and/or training one or more models therefor, in accordance with certain aspects. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 514. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other aspects, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative aspects.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 602. Cloud infrastructure system 602 then performs processing to provide the services requested in the tenant's subscription order. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public tenant, where the tenant can be an individual or an enterprise. In certain other aspects, under a private cloud model, cloud infrastructure system 602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 602 and the services provided may be shared by several organizations in a related community. Various other models such as hybrids of the above mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602.

In some aspects, the processing performed by cloud infrastructure system 602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain aspects, to facilitate efficient provisioning of these resources for supporting the various cloud services provided by cloud infrastructure system 602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a tenant may, using a client device, request (service request 634) one or more services provided by cloud infrastructure system 602 using one or more of interfaces 614, 616, and 618. For example, a tenant may access the online store, browse cloud services offered by cloud infrastructure system 602, and place a subscription order for one or more services offered by cloud infrastructure system 602 that the tenant wishes to subscribe to. The service request may include information identifying the tenant and one or more services that the tenant desires to subscribe to. For example, a tenant may place a subscription order for a chatbot related service offered by cloud infrastructure system 602. As part of the order, the client may provide information identifying the input (e.g. utterances).

In certain aspects, such as the embodiment depicted in FIG. 6, cloud infrastructure system 602 may comprise an order management subsystem (OMS) 620 that is configured to process the new order. As part of this processing, OMS 620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 602 may send a response or notification 644 to the requesting tenant to indicate when the requested service is now ready for use. In some instances, information (e.g., a link) may be sent to the tenant that enables the tenant to start using and availing the benefits of the requested services.

Cloud infrastructure system 602 may provide services to multiple tenants. For each tenant, cloud infrastructure system 602 is responsible for managing information related to one or more subscription orders received from the tenant, maintaining tenant data related to the orders, and providing the requested services to the tenant or clients of the tenant. Cloud infrastructure system 602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 602 may provide services to multiple tenants in parallel. Cloud infrastructure system 602 may store information for these tenants, including possibly proprietary information. In certain aspects, cloud infrastructure system 602 comprises an identity management subsystem (IMS) 628 that is configured to manage tenant's information and provide the separation of the managed information such that information related to one tenant is not accessible by another tenant. IMS 628 may be configured to provide various security-related services such as identity services, such as information access management, authentication and authorization services, services for managing tenant identities and roles and related capabilities, and the like.

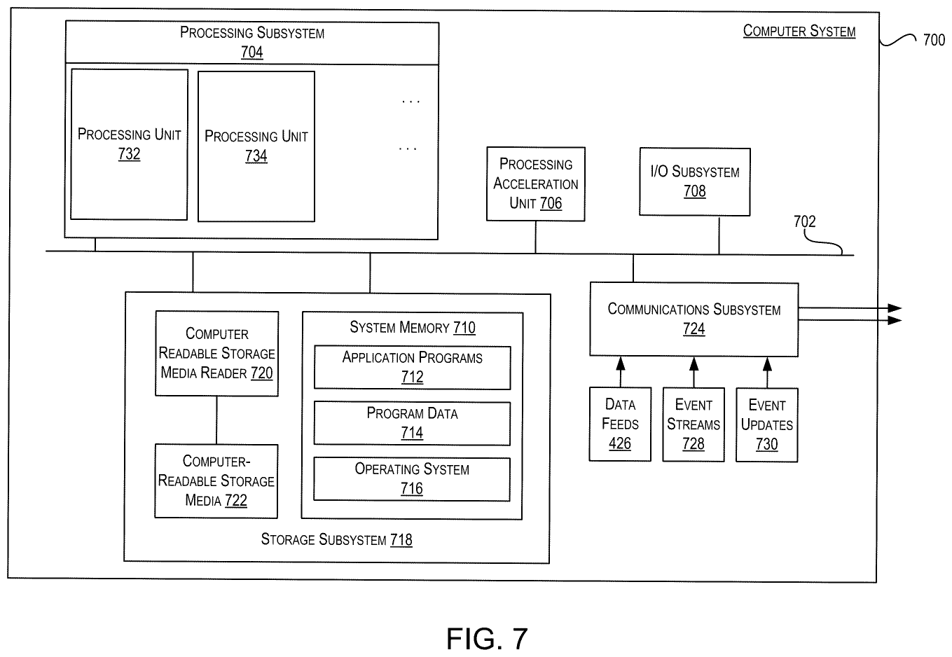

FIG. 7 illustrates an exemplary computer system 700 that may be used to implement certain aspects. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative aspects of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some aspects, processing subsystem 704 can include one or more special purpose co-processors such as graphics processors, digital signal processors (DSPs), or the like. In some aspects, some or all of the processing units of processing subsystem 704 can be implemented using customized circuits, such as application specific integrated circuits (ASICs), or field programmable gate arrays (FPGAs).

In some aspects, the processing units in processing subsystem 704 can execute instructions stored in system memory 710 or on computer readable storage media 722. In various aspects, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain aspects, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some aspects. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 722 may store programming and data constructs that provide the functionality of some aspects. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, digital video disc (DVD), a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 718 may also include a computer-readable storage media reader 720 that can further be connected to computer-readable storage media 722. Reader 720 may receive and be configured to read data from a memory device such as a disk, a flash drive, etc.

In certain aspects, computer system 700 may support virtualization technologies, including but not limited to virtualization of processing and memory resources. For example, computer system 700 may provide support for executing one or more virtual machines. In certain aspects, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices. For example, the communications subsystem may be used to transmit a response to a user regarding the inquiry for a chatbot.

Communications subsystem 724 may support both wired and/or wireless communication protocols. For example, in certain aspects, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 724 can provide wired network connectivity (e.g., Ethernet) in addition to or instead of a wireless interface.

Communications subsystem 724 can receive and transmit data in various forms. For example, in some aspects, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art can appreciate other ways and/or methods to implement the various aspects.

### Example 1

In the realm of cybersecurity, the development of an advanced threat detection system begins with the crucial task of data aggregation. This initial Example focuses on collecting and centralizing data from various sources across the network, including firewall logs, Intrusion Detection System (IDS) alerts, server access logs, application logs, etc. All These diverse data streams are aggregated into a secure data lake, where they undergo a normalization process to ensure consistent formatting (Block 1 of FIG. 1). This centralization allows for comprehensive analysis and sets the foundation for effective threat detection.

With the data aggregated and normalized, the system then applies a series of pre-trained algorithms to detect potential threats (Block 2 of FIG. 1). An anomaly detection algorithm scans the data to identify unusual network patterns that deviate from the norm. Simultaneously, a signature-based detection system flags any patterns matching known malware signatures. A behavioral analysis algorithm also runs in parallel, focusing on detecting suspicious user activities. The output of this step is an unaligned detection portfolio, containing all events flagged by these algorithms, regardless of their actual threat level.

The unaligned detections are then organized into a user-friendly interface for expert review. Cybersecurity analysts examine a subset of these detections, categorizing them as true positives (actual threats), false positives (benign activities incorrectly flagged), or unknowns requiring further investigation. To enrich the dataset, a pre-trained Large Language Model (LLM) is employed to generate additional hypothetical threat scenarios. These generated scenarios are also reviewed and labeled by the experts, adding diversity to the dataset and helping to cover a wider range of potential threats as depicted in (Block 3 of FIG. 1).

Building upon this expert-labeled data, the labeling-coordination model and the generative AI technique(s) substantially expand the dataset. (Block 4 of FIG. 1.) The labeling-coordination model and/or generative AI technique(s) analyze patterns in both the labeled data and raw logs to create synthetic data points. It generates variations of true positive threats, creates new examples of benign activities that might be mistaken for threats, and produces edge cases to improve the robustness of the eventual model. Through this process, the initial dataset of e.g. 1,000 labeled points is expanded to a comprehensive set of 10,000 data points, providing a much richer foundation for training the Context AI Agent (CAIA). The expanded dataset can include a higher representation (or even a majority or vast majority representation) of true negatives.

With this expanded dataset in hand, the development of the Context AI Agent (CAIA) begins. (Block 5 of FIG. 1.) The process starts by using transfer learning from a pre-trained Large Language Model (LLM), which provides a solid foundation of general cybersecurity knowledge. This model is then fine-tuned on the organization-specific expanded dataset, allowing the context AI agent to learn the unique patterns and threats relevant to the network. The context AI agent is trained to perform three functions: filtering incoming detections based on relevance and confidence, aligning high-confidence detections with known threat categories, and generating detailed threat reports for each potential issue identified for the purpose of explainability.

The context AI agent is deployed to process new unaligned detections in real-time. (Block 6 of FIG. 1.) As network data streams in, the context AI agent filters out low-confidence alerts, aligns high-confidence detections with appropriate threat categories, and generates comprehensive reports for each potential threat. Cybersecurity experts then review context AI agent's output, validating threat classifications, providing feedback on any false positives or negatives, and suggesting new threat categories or detection criteria as needed. This expert feedback is used to create new labels, which are fed back into the system. Periodically, the context AI agent is retrained with this updated dataset, creating a continuous improvement loop that allows the threat detection system to evolve and adapt to new and emerging cybersecurity challenges.

### Example 2

The following pseudocode corresponds to some embodiments of the invention:

```
function CAIAInference(unalignedDetectionPortfolios):
  # Initialize empty lists for results
  filteredDetections = [ ]
  alignedDetections = [ ]
  generatedReports = [ ]
  # Process each detection in the unaligned portfolios
  for detection in unalignedDetectionPortfolios:
    # Filter step
    if CAIA.isRelevant(detection):
      filteredDetections.append(detection)
      # Align step
      alignedDetection = CAIA.alignDetection(detection)
      alignedDetections.append(alignedDetection)
      # Generate report step
      report = CAIA.generateReport(alignedDetection)
      generatedReports.append(report)
  return filteredDetections, alignedDetections, generatedReports
function ExpertReview(generatedReports):
  feedback = [ ]
  newLabels = [ ]
  for report in generatedReports:
    # Expert reviews the report
    expertFeedback = getExpertFeedback(report)
    feedback.append(expertFeedback)
    # Create new labels based on feedback
    if expertFeedback.requiresNewLabel:
      newLabel = createNewLabel(report, expertFeedback)
      newLabels.append(newLabel)
  return feedback, newLabels
function UpdateCAIA(feedback, newLabels):
  # Update CAIA model with new feedback and labels
  CAIA.updateModel(feedback, newLabels)
# Main inference loop
while True:
  # Get new unaligned detection portfolios
  newDetections = getNewDetections( )
  # Run CAIA inference
  filteredDetections, alignedDetections, reports =
  CAIAInference(newDetections)
  # Get expert review
  feedback, newLabels = ExpertReview(reports)
  # Update CAIA with new information
  UpdateCAIA(feedback, newLabels)
```

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a pre-trained context AI agent that was trained using one or more initial training data sets;
generating an input data set that includes a prompt and/or context to request generation of one or more synthetic data elements;
accessing a result that includes at least one synthetic data element, wherein the result was generated by a natural language processing technique in response to the input data set;
facilitating identifying a label for each of the at least one synthetic data element; and
fine-tuning the context AI agent using the label for each of the at least one synthetic data element.

2. The computer-implemented method of claim 1, further comprising:
receiving a new data element;
generating one or more prediction variables by processing the new data element using the fine-tuned context AI agent;
determining that an alert condition or action condition is satisfied based on the one or more prediction variables; and
initiating an alert or action based on the determination.

3. The computer-implemented method of claim 2, wherein the one or more prediction variables include a label for the new data element, wherein initiating the alert or action includes outputting a communication to a user device to request confirmation of, rejection of, or modification of the label for the new data element.

4. The computer-implemented method of claim 1, further comprising:
identifying that each of one or more real data elements and/or one or more existing synthetic data elements are associated with a confidence metric that is below a relative or absolute threshold;
wherein generating the input data set includes defining the prompt and/or context to include the one or more real data elements and/or one or more existing synthetic data elements as an example or template.

5. The computer-implemented method of claim 1, further comprising:
identifying that each of one or more real data elements and/or one or more existing synthetic data elements that are within a set of client-specific data elements are associated with a prevalence metric that is below a relative or absolute threshold, wherein the prevalence metric is indicative of a degree of representation of a label, syntax, structure, or field inclusion within the client-specific data elements is below an absolute or relative threshold;
wherein generating the input data set includes defining the prompt and/or context to include the one or more real data elements and/or one or more existing synthetic data elements as an example or template.

6. The computer-implemented method of claim 1, wherein the result is generated based on a confidence metric assigned to at least one label in the one or more initial training data sets.

7. The computer-implemented method of claim 1, wherein the result is generated based on a representation metric in a multi-dimensional space representing the one or more initial training data sets.

8. A system comprising:
one or more processors;
one or more non-transitory computer-readable media storing instructions, which, when executed by the system, cause the system to perform a set of actions including:
accessing a pre-trained context AI agent that was trained using one or more initial training data sets;
generating an input data set that includes a prompt and/or context to request generation of one or more synthetic data elements;
accessing a result that includes at least one synthetic data element, wherein the result was generated by a natural language processing technique in response to the input data set;
facilitating identifying a label for each of the at least one synthetic data element; and
fine-tuning the context AI agent using the label for each of the at least one synthetic data element.

9. The system of claim 8, wherein the set of actions further includes:
receiving a new data element;
generating one or more prediction variables by processing the new data element using the fine-tuned context AI agent;
determining that an alert condition or action condition is satisfied based on the one or more prediction variables; and
initiating an alert or action based on the determination.

10. The system of claim 9, wherein the one or more prediction variables include a label for the new data element, wherein initiating the alert or action includes outputting a communication to a user device to request confirmation of, rejection of, or modification of the label for the new data element.

11. The system of claim 8, wherein the set of actions further includes:
identifying that each of one or more real data elements and/or one or more existing synthetic data elements are associated with a confidence metric that is below a relative or absolute threshold;
wherein generating the input data set includes defining the prompt and/or context to include the one or more real data elements and/or one or more existing synthetic data elements as an example or template.

12. The system of claim 8, wherein the set of actions further includes:
identifying that each of one or more real data elements and/or one or more existing synthetic data elements that are within a set of client-specific data elements are associated with a prevalence metric that is below a relative or absolute threshold, wherein the prevalence metric is indicative of a degree of representation of a label, syntax, structure, or field inclusion within the client-specific data elements is below an absolute or relative threshold;
wherein generating the input data set includes defining the prompt and/or context to include the one or more real data elements and/or one or more existing synthetic data elements as an example or template.

13. The system of claim 8, wherein the result is generated based on a confidence metric assigned to at least one label in the one or more initial training data sets.

14. A computer-program product tangibly embodied in a non-transitory machine-readable storage medium, including instructions configured to cause one or more data processors to perform a set of actions including:
accessing a pre-trained context AI agent that was trained using one or more initial training data sets;
generating an input data set that includes a prompt and/or context to request generation of one or more synthetic data elements;
accessing a result that includes at least one synthetic data element, wherein the result was generated by a natural language processing technique in response to the input data set;
facilitating identifying a label for each of the at least one synthetic data element; and
fine-tuning the context AI agent using the label for each of the at least one synthetic data element.

15. The computer-program product of claim 14, wherein the set of actions further includes:
receiving a new data element;
generating one or more prediction variables by processing the new data element using the fine-tuned context AI agent;
determining that an alert condition or action condition is satisfied based on the one or more prediction variables; and
initiating an alert or action based on the determination.

16. The computer-program product of claim 15, wherein the one or more prediction variables include a label for the new data element, wherein initiating the alert or action includes outputting a communication to a user device to request confirmation of, rejection of, or modification of the label for the new data element.

17. The computer-program product of claim 14, wherein the set of actions further includes:
identifying that each of one or more real data elements and/or one or more existing synthetic data elements are associated with a confidence metric that is below a relative or absolute threshold;
wherein generating the input data set includes defining the prompt and/or context to include the one or more real data elements and/or one or more existing synthetic data elements as an example or template.

18. The computer-program product of claim 14, wherein the set of actions further includes:
identifying that each of one or more real data elements and/or one or more existing synthetic data elements that are within a set of client-specific data elements are associated with a prevalence metric that is below a relative or absolute threshold, wherein the prevalence metric is indicative of a degree of representation of a label, syntax, structure, or field inclusion within the client-specific data elements is below an absolute or relative threshold;
wherein generating the input data set includes defining the prompt and/or context to include the one or more real data elements and/or one or more existing synthetic data elements as an example or template.

19. The computer-program product of claim 14, wherein the result is generated based on a confidence metric assigned to at least one label in the one or more initial training data sets.

20. The computer-program product of claim 14, wherein the result is generated based on a representation metric in a multi-dimensional space representing the one or more initial training data sets.
